(19) United States
(12) Patent Application Publication
(10) Pub. No.: US 2015/0138769 A1
(43) Pub. Date: May 21, 2015

(54) LIGHT EMITTING DIODE STREET LIGHT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MI-CHIEN CHEN, New Taipei (TW); SHIEN-CHENG KUO, New Taipei (TW); JUAN MO, Shenzhen (CN)

(21) Appl. No.: 14/508,845

(22) Filed: Oct. 7, 2014

(30) Foreign Application Priority Data
Nov. 19, 2013 (CN) 201310577197.0

(51) Int. Cl. F21V 29/00; F21V 13/02; F21K 99/00

(52) U.S. Cl. CPC F21V 29/262; F21K 9/50; F21V 13/02; F21Y 2101/02
USPC 362/240

(57) ABSTRACT

An LED street light includes a bottom cover, a lamp board positioned on the bottom cover, a top cover coupled with the bottom cover and positioned above the lamp board, and a plurality of lenses mounted on the top cover. A majority of the top cover and the bottom cover are made of thermally conductive material. The bottom cover comprises a plurality of heat dissipation columns spaced from each other. The top cover includes a plurality of recesses for transmitting light from the lamp board, and the recesses are substantially annularly shaped.

### FIELD

The subject matter herein generally relates to street lights, and in particular to a light emitting diode (LED) street light.

### BACKGROUND

Light emitting diodes (LEDs) are being used in outdoor lighting devices (such as, street lights). Heat dissipation is an issue to be addressed in the manufacturing of an LED street light.

### BRIEF DESCRIPTION OF THE DRAWINGS

Implementations of the present technology will now be described, by way of example only, with reference to the attached figures.

FIG. 1 is an isometric view of an LED street light according an embodiment of this disclosure.

FIG. 2 is an exploded view of the LED street light of FIG. 1.

FIG. 3 is an isometric view of a bottom cover of the LED street light as shown in FIG. 2.

FIG. 4 is an isometric view of a lamp board of the LED street light as shown in FIG. 2.

FIG. 5 is an isometric view of a top cover of the LED street light as shown in FIG. 2.

FIG. 6 is a cross-sectional, isometric view of the LED street light of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “substantially” is defined to be essentially conforming to the particular dimension, shape or other feature that is modified by the word “substantially”, such that the feature of the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

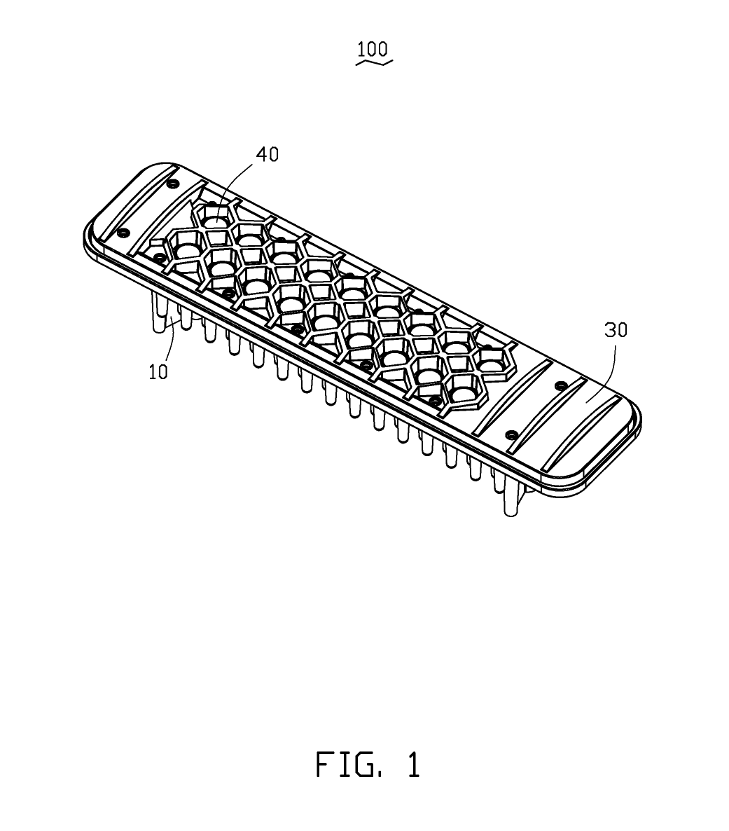

FIG. 1 illustrates an LED street light 100 of the disclosure. The street light 100 can include a bottom cover 10, a top cover 30, and a plurality of lenses 40. The bottom cover 10 can be coupled with the top cover 30 to cooperatively form a receiving space. The lenses 40 can be mounted on the top cover 30.

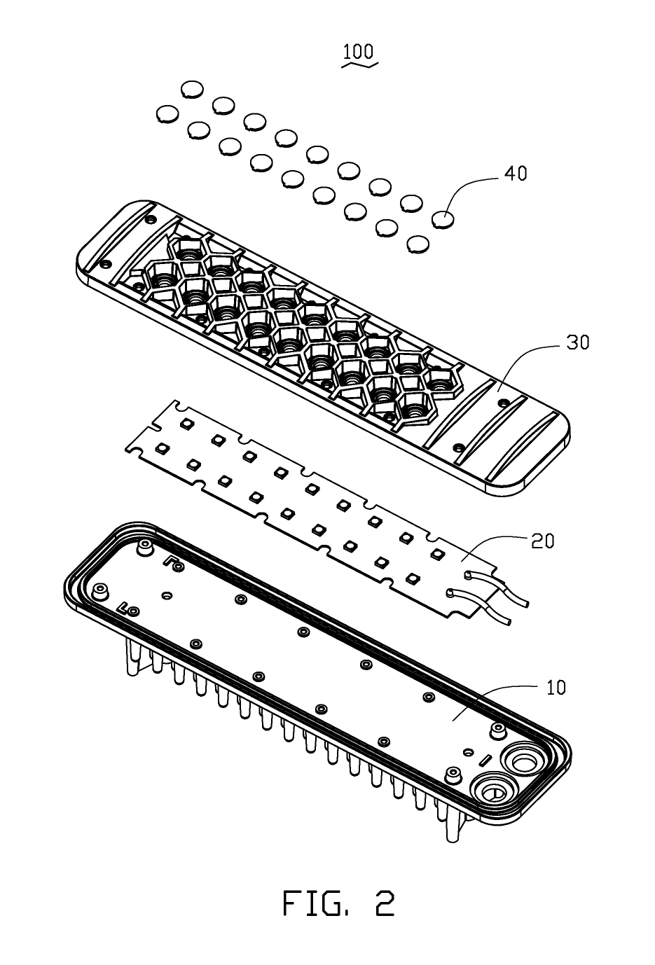

FIG. 2 illustrates that the LED street light 100 can further include a lamp board 20. The lamp board 20 can be positioned between the top cover 30 and the bottom cover 10.

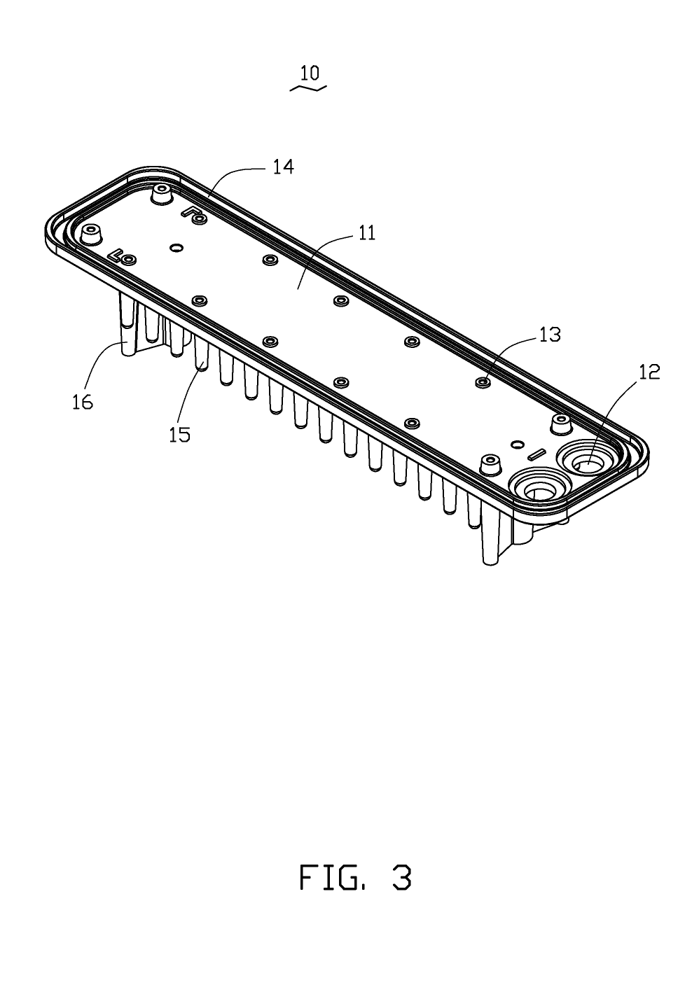

FIG. 3 illustrates that the bottom cover 10 can be substantially rectangular. A majority or the whole of the bottom cover 10 can be made of polyamide doped with graphite. In other embodiments, the bottom cover 10 can be made of other plastic thermally conductive materials. The bottom cover 10 can include a base plate 11, which can define two through holes 12 on one side. The through holes 12 can be, but are not limited to, substantially circular. One surface of the base plate 11 adjacent to the lamp board 20 can define at least one threaded blind hole 13 and a ridge 14 along the edge of the base plate 11. The ridge 14 can be annular around the bottom cover 10.

The surface of the base plate 11 away from the lamp board 20 can include a plurality of heat dissipation columns 15. The heat dissipation columns 15 can be positioned in an array, and can be cylindrical or frustoconical. The end of each heat dissipation column 15 away from the bottom cover 10 can have a smaller diameter than the other end. The heat dissipation columns 15 can be spaced from each other to enable the passing of air. The heat dissipation columns 15 can be made of polyamide doped with graphite, and can be integrated with the base plate 11, whereby the heat dissipation columns 15 can radiate the heat generated in the LED street light 100. In other embodiments, the heat dissipation columns 15 can be made of other plastic thermally conductive materials. The bottom cover 10 can include at least one assembling portion 16 on the surface of the base plate 11 away from the lamp board 20, and the assembling portion 16 can be configured to connect the LED street light 100 and a lamp holder (not shown). In at least one embodiment, there can be two assembling portions 16. The assembling portion 16 can be, but is not limited to, a screwed cap.

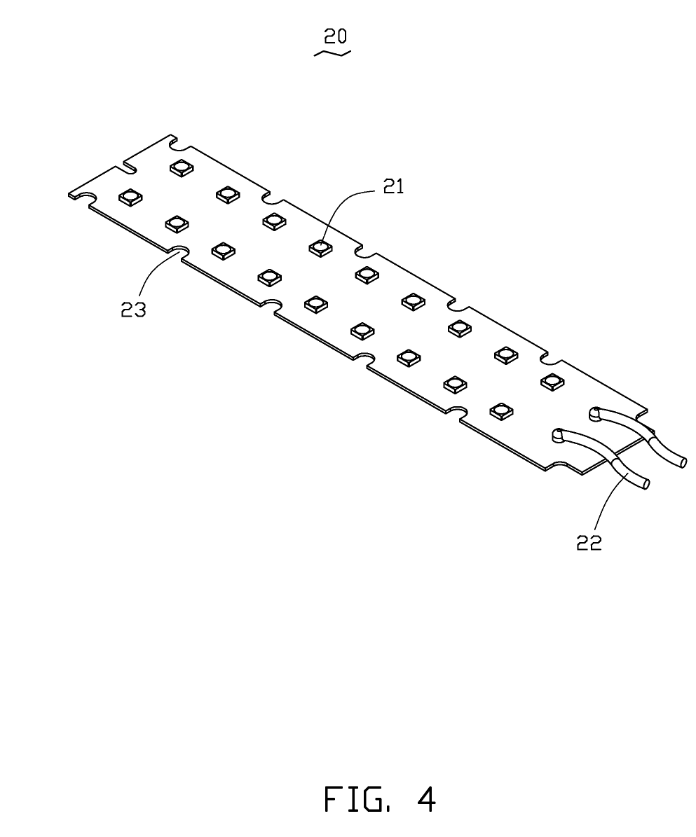

FIG. 4 illustrates that the lamp board 20 can be substantially rectangular, and can include a plurality of LEDs 21 on a surface toward the top cover 30. In at least one embodiment, the LEDs 21 can be arranged in two parallel lines. In other embodiments, the LEDs 21 can be arranged in other patterns. The surface of the lamp board 20 adjacent to the top cover 30 can include a reflective film (not shown). One end of the lamp board 20 can include two electrode leads 22, which can be connected to positive and negative terminals of a power supply (not shown) through the through holes 12. The lamp board 20 can define at least one cutout 23 on the periphery. The cutouts 23 of the lamp board 20 can be spaced from each other and can be positioned corresponding to and mating with the blind holes 13.

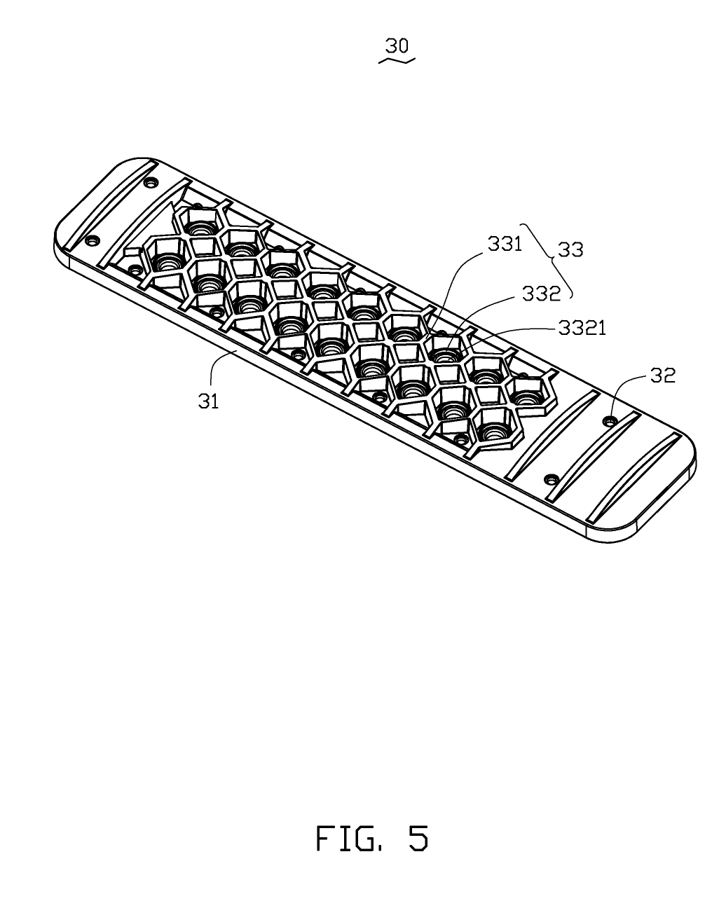

FIG. 5 illustrates that the top cover 30 can be rectangular and can include an annular flange 31 along the edge, at least one threaded through hole 32, and a plurality of recesses 33. A majority or the whole of the top cover 30 can be made of polyamide doped with graphite. In other embodiments, the top cover 30 can be made of other thermally conductive materials. In at least one embodiment, the threaded through holes 32 can be arranged corresponding to, and mating with, the threaded blind holes 13 of the bottom cover 10 and the cutouts 23. A plurality of screws (not shown) can be threaded in the threaded through holes 32 and the threaded blind holes 13 to connect the bottom cover 10 and the top cover 30. The recesses 33 can be arranged in an array on the surface of the lamp cover 30 away from the lamp board 20. The recesses 33 can be annularly closed. In at least one embodiment, the recesses 33 can be hexagonal. In other embodiments, the recesses 33 can be other shapes, such as pentagonal. Each of the recesses 33 can include a plurality of sidewalls 331 and a bottom portion 332. The bottom portion 332 can define a lamp hole 3321 in the central portion configured for transmitting the light. The sidewalls 331 can be substantially perpendicular to the bottom portion 332. In at least one embodiment, the number of sidewalls 331 can be six. The sidewalls 331 can increase the heat dissipation area.

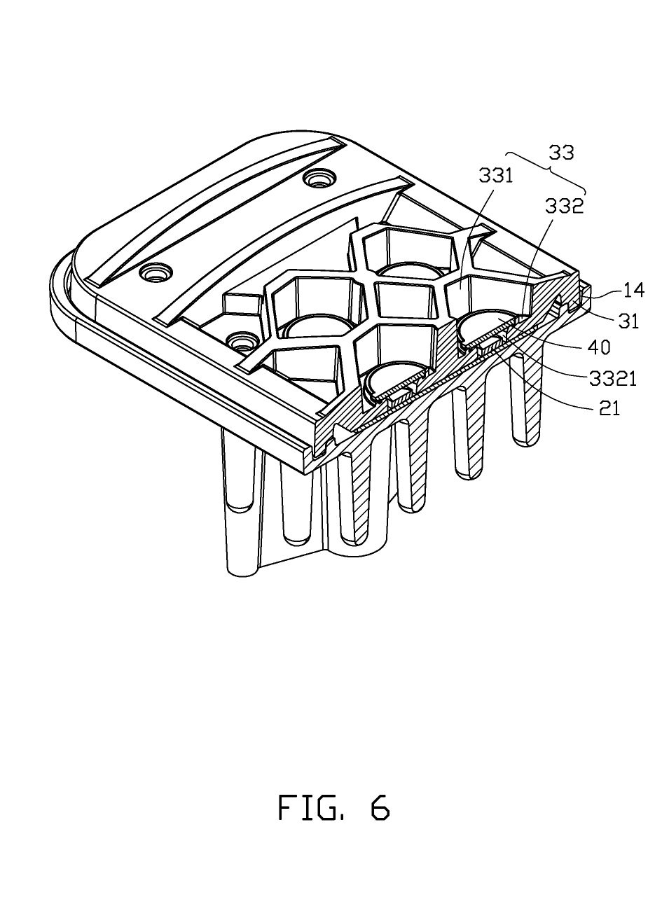

FIG. 6 illustrates that the flange 31 can be latched in the ridge 14 of the bottom cover 10, and the top cover 30 can thereby be coupled with the bottom cover 10. In at least one embodiment, a sealing adhesive (not shown) can be applied between the flange 31 and the ridge 14. In other embodiments, a gasket can be arranged between the flange 31 and the ridge 14.

The lamp holes 3321 can be arranged corresponding to the LEDs 21 on the lamp board 20. The lamp hole 3321 can be circular, and the size of the lamp holes 3321 can be matching with the LED 21, whereby an LED 21 can be received in the lamp holes 3321. The light emitted from the LEDs 21 can be transmitted to the outside of the LED street light 100 through the lamp holes 3321. The lamp hole 3321 can be rectangular, pentagonal, or other shapes. In at least one embodiment, the recesses 33 can be arranged in two parallel lines on the top cover 30, and the recesses 33 can be contiguous. In other embodiments, the recesses 33 can be arranged in other patterns, corresponding to the arrangement of the LEDs 21. As the recesses 33 can include a plurality of sidewalls 331, the area of heat dissipation can be increased. In at least one embodiment, the sidewalls 331 can be coated with a reflective layer.

The lenses 40 can be disk shaped and made of transparent materials. Each lens 40 can overlay the corresponding lamp hole 3321 of the top cover 30 respectively. The lenses 40 can be positioned above the lamp holes 3321, whereby the light emitted from the LEDs 21 can be transmitted to the outside of the LED street light 100 through the lenses 40. The lenses 40 can be made of polycarbonate, which has high ductility and good optical properties.

In assembling, the lamp board 20 can be positioned in, and pressed against, the bottom cover 10 by the thermally conductive adhesive. The cutouts 23 can be positioned corresponding to the blind holes 13, and the electrode leads 22 can be positioned in the two through holes 12 of the bottom cover 10, whereby the electrode leads 22 can be connected with an external power supply of the LED street light 100. In other embodiments, the lamp board 20 can be mounted in the bottom cover by screws.

In such an embodiment, the top cover 30 can be positioned above the lamp board 20, the flange 35 can be latched in the ridge 14 of the bottom cover 10, and a thermal adhesive can be dispensed between the flange 35 and the ridge 14. The periphery of the bottom cover 10 and the top cover 30 can therefore be sealed. At this time, the lamp board 20 can be pressed close to the bottom cover 10, and the LEDs 21 can be received in the lamp holes 3321 of the recesses 33. Then, the bottom cover 10, the lamp board 20, and the top cover 30 can be fixed together by screws. After that, the lenses 40 can be arranged on the lamp holes 3321 of the top cover 30, and can be connected with the top cover 30 by a thermal adhesive. The LED street light 100 can be assembled.

As the top cover 30 and the bottom cover 10 can be made of plastic thermally conductive materials, the top cover 30 and the bottom cover 10 can be used to dissipate heat, and the weight of the LED street light 100 can be lighter than a normal LED street light. Moreover, as the bottom cover 10 can include a plurality of heat dissipation columns 15, the heat generated by the lamp board 20 can be transmitted to the bottom cover 10 and the heat dissipation columns 15 quickly, and the heat radiation efficiency of the LED street light 100 can be improved. The top cover 30 can include a plurality of recesses 33 and a number of sidewalls 331, the sidewalls 331 can increase the area of heat dissipation. The marginal adaptation of the LED street light 100 can be increased.

The embodiments shown and described above are only examples. Many details are often found in the art such as the other features of a LED street light. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A light-emitting diode (LED) street light comprising:
a bottom cover and a top cover coupled together with a lamp board positioned therebetween, wherein a majority of each of the top and bottom covers is composed of thermally conductive material; and
the bottom cover comprises a plurality of spaced apart heat dissipation columns and the top cover comprises a plurality of substantially annularly shaped recesses, each recess associated with a light emitting diode on the lamp board for directing light therefrom.

2. The LED street light of claim 1, wherein the each of the plurality of the recesses comprises a plurality of sidewalls and a bottom portion; the sidewalls are substantially perpendicular to the bottom portion; and the bottom portion defines a lamp hole for transmitting light in the central portion thereof.

3. The LED street light of claim 2, wherein the recesses are hexagonal and has six sidewalls; the sidewalls are connected to each other.

4. The LED street light of claim 2, wherein the recesses are arranged in parallel lines and are continuous.

5. The LED street light of claim 2, wherein the lamp board comprises a plurality of LEDs, and an LED is received in a lamp hole.

6. The LED street light of claim 2, wherein further comprises a plurality of lenses, the lens are disk shaped and overlay lamp holes of the recesses.

7. The LED street light of claim 1, wherein the heat dissipation columns are integrated with the bottom cover.

8. The LED street light of claim 1, wherein the heat dissipation columns are column shaped.

9. The LED street light of claim 1, wherein the heat dissipation columns are spike shaped.

10. The LED street light of claim 1, wherein one end of the heat dissipation column away from the bottom cover has a smaller diameter than the other end.

11. The LED street light of claim 1, wherein the top cover further comprises a flange, and the bottom cover further comprises a ridge on a surface toward the lamp board; the flange is latched in the ridge.

12. The LED street light of claim 1, wherein the bottom cover further comprises two through holes, and the lamp board further comprises two electrode leads; the electrode leads passes through the through holes.

13. The LED street light of claim 1, wherein the bottom cover further comprises at least one threaded blind hole, and the top cover further comprises at least one threaded through hole positioned corresponding to and mating with the at least one threaded blind hole.

14. The LED street light of claim 13, wherein the lamp board further comprises at least one cutout positioned corresponding to and mating with the at least one threaded blind hole.

15. The LED street light of claim 1, wherein the bottom cover and the top cover are made of plastic thermal conductive materials.

16. The LED street light of claim 15, wherein the bottom cover and the top cover are made of polyamide doped with graphite.
